(19) United States
(12) Patent Application Publication
(10) Pub. No.: US 2025/0092885 A1
(43) Pub. Date: Mar. 20, 2025

(54) Hydraulic Accumulator

(71) Applicant: Hydac Technology GmbH, Sulzbach / Saar (DE)

(72) Inventor: Norbert Weber, Saarsbrücken (DE)

(73) Assignee: Hydac Technology GmbH, Sulzbach / Saar (DE)

(21) Appl. No.: 18/727,455

(22) PCT Filed: Jan. 18, 2023
(86) PCT No.: PCT/EP2023/051114

§ 371 Date: Jul. 9, 2024

(30) Foreign Application Priority Data
Feb. 10, 2022 (DE) 10 2022 000 511.5

(51) Int. Cl. F15B 1/24; F15B 1/22

(52) U.S. Cl. CPC F15B 1/24; F15B 1/22; F15B 2201/312; F15B 2201/405; F15B 2201/41

(57) ABSTRACT

The disclosure relates to a hydraulic accumulator, in particular in the form of a piston-type accumulator, having a separating element which is arranged in an accumulator housing and separates two fluid chambers from one another in a fluid-tight manner, in particular a closed accumulator chamber comprising a working gas from a liquid chamber comprising an operating liquid such as hydraulic oil, wherein a fluid connector is fluidically connected to one of the fluid chambers, wherein outside the accumulator housing and fixed thereto is an attachment part with a magnetic field generating device which acts on a fluid connection between the fluid connector of the accumulator housing and a fluid connector of the attachment part in such a way that magnetisable particles can be separated in a cleaning manner from the fluid passing through the fluid connection.

### CROSS-REFERENCE TO RELATED APPLICATIONS

This application claims priority to German Patent Application No. DE 10 2022 000 511.5, filed on Feb. 10, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a hydraulic accumulator, in particular in the form of a piston accumulator, having a separating element, which is arranged in an accumulator housing and separates two fluid chambers from one another in a fluid-tight manner, in particular a closed accumulator chamber comprising a working gas from a liquid chamber comprising an operating liquid, such as hydraulic oil, wherein a fluid port is fluidically connected to one of the fluid chambers.

Hydraulic accumulators, such as (hydropneumatic) piston accumulators, are used in hydraulic systems to receive defined volumes of pressurised liquid, such as hydraulic oil, and return them to the system if necessary. In the hydropneumatic piston accumulators that are usually used, in which the piston separates the oil-side liquid chamber from the accumulator chamber contained in the accumulator housing that receives a working gas such as nitrogen gas, the position of the piston changes during operation of the hydraulic accumulator such that the hydraulic accumulator receives hydraulic oil when the pressure rises, with the working gas in the other fluid or accumulator chamber being compressed at the same time during this process. When the pressure falls, the gas thus compressed expands again and in the process pushes stored hydraulic oil back into the hydraulic operating circuit. Due to the resulting changes in the volumes of the working chambers arising during operation, this results in a corresponding axial movement of the piston inside the accumulator housing in each case.

As such, during operation of hydraulic devices such as operating cylinders, for example, corresponding hydraulic accumulators are connected to the hydraulic operating circuit, which generally comprises filter devices with filter elements to clean particulate contamination from an operating fluid, such as the hydraulic oil, and said filter devices can be replaced with new elements if necessary. Despite these filter devices, the possibility cannot be ruled out that contaminated particles might pass to the clean side of the fluid and then cause damage in the hydraulic accumulator and its components once inside the corresponding accumulator. Filter elements are also limited with regard to their throughput capacity, with the result that these cannot always be used with very high flow rates and corresponding high fluid pressures. Particularly using piston when accumulators, particulate contamination can inadvertently pass into the sealing system of the separating piston, which can cause failure of the accumulator and any connected hydraulic equipment. As the arising particulate contamination is frequently the result of abrasion on the hydraulic devices, these are generally metallic in nature and any such particles that arise, particularly in the event of mechanical failure, may also be of such a magnitude as to cause the sealing devices on the separating piston along with their elastomer material to leak or even be destroyed.

DE 41 16 482 A1 discloses a method and device for measuring the pressure of a working gas in a gas pressure accumulator which can be connected to a hydraulic operating circuit and in which the working gas is separated from the operating or working liquid by means of a separating element in the form of an elastomer accumulator bladder. When the accumulator bladder is in a predefinable position, the gas pressure that can be assigned to the bladder in this position is measured by means of a pressure transducer arranged on the fluid side, for which purpose the position of a disc valve of the accumulator is monitored by means of a monitoring device. For this purpose, the disc valve comprises a switching element with a permanent magnet in a fluid port of the accumulator and the associated sensor consists of a switch that can be actuated by the magnet or uses the so-called Hall effect as soon as the switching element moves past the corresponding sensor as a function of the actuating position of the disc valve and triggers said sensor accordingly.

The cuboid magnet thus moving continuously to and from during operation of the accumulator is as ill-suited as annular magnet on the gas side of the accumulator housing to effectively counteracting particulate contamination arising on the liquid side in the accumulator.

### SUMMARY

A need exists to improve a hydraulic accumulator such that a possibility of a failure can be reduced even in the event of metallic particulate contamination.

The need is addressed by the subject matter of the independent claim(s). Embodiments of the invention are described in the dependent claims, the following description, and the drawings.

### BRIEF DESCRIPTION OF THE DRAWINGS

shows the main structure of an example hydraulic FIG. 1 accumulator in the form of a longitudinal section;

FIG. 2 shows an enlarged view of the section referred to as X in FIG. 1;

FIG. 3 shows a view from beneath the example hydraulic accumulator according to FIG. 1;

FIGS. 4 and 5 show a second embodiment corresponding to FIGS. 1 and 2;

FIGS. 6 to 8 show a third embodiment corresponding to FIGS. 1 to 3; and

FIGS. 9 to 11 show a fourth embodiment corresponding to FIGS. 1 to 3.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, an attachment part with a magnetic-field-generating device is provided outside the accumulator housing and fixed thereto, said magnetic-field-generating device acting on a fluid connection between the fluid port of the accumulator housing and a fluid port of the attachment part in such a way that magnetisable particles can be separated in a cleaning manner from the fluid passing through the fluid connection. This provides an opportunity to allow a sufficiently strong magnetic field, fixed in position, to arise in the fluid port region of the accumulator housing such that magnetisable, in particular metallic, particles can no longer pass onto the liquid side of the accumulator and thus are likewise unable to cause damage, in particular damage to the separating element, such as a separating piston. In particular, the magnetisable particles can be securely collected outside the accumulator housing such that these are unable to unintentionally pass onto the liquid side of the accumulator.

In this manner, the particulate contamination cannot pass onto the sealing side of the separating piston with its sealing rings and guide bands of a hydropneumatic piston accumulator, which may otherwise, alongside sealing problems, also cause the separating piston inside the accumulator housing to ‘catch’ due to friction, meaning that the separating piston can no longer execute any movements, which would make the hydraulic accumulator in its entirety unusable. In particular, when managing fluid flows where filter devices are at the limits of their capacity, this achieves a means of reliably cleaning metallic, magnetisable particle parts from the fluid flow by means of magnetic separation, which takes place upstream of the hydraulic accumulator.

In some embodiments, it is provided that the attachment part is designed as a cuboid or parallelepiped and, furnished with an engagement part, is screwed into the accumulator housing or connected flush with the accumulator housing via a plate-like flange connection. In this way, the attachment part can be accommodated in a space-saving manner on the underside of the hydraulic accumulator in its vertical operating position and, as such, forms part of an assigned piping system, by means of which the piston accumulator can be connected to a standard hydraulic circuit, with associated pressure supply devices, such as hydraulic pumps, and hydraulic consumers such as operating cylinders.

As such, it is for example provided that the accumulator housing comprises a cylindrical housing wall, which is sealed with a housing lid at at least one end, said housing lid comprising the attachment part on its outer side, or underside respectively, facing away from the separating piston.

In some embodiments, it is provided that the fluid connection inside the attachment part runs in a straight line, coaxially with respect to the fluid port, or at right angles thereto, and that the magnetic-field-generating device is arranged transversely, at least with respect to parts of the fluid passage and engaging in said fluid passage in the attachment part. The transverse path of the magnetic-field-generating device with respect to the fluid flow moving inside the fluid connection guarantees that fluid passes the device over a relatively long distance so that it is possible to ‘fish out’ the relevant particulate contamination in a particularly efficient manner before the fluid enters the accumulator housing.

In some embodiments, the magnetic-field-generating device is formed by a permanent magnet, allowing magnetisable particles to be removed from the fluid flow without applying any external energy. However, in special cases it would also be conceivable to use a magnet through which a current can be passed instead of a permanent magnet to increase efficiency, although this would then require a corresponding energy supply to the accumulator housing of the hydraulic accumulator and/or its attachments.

In this case, it is for example provided that the permanent magnet comprises a magnetic rod, which is inserted into the fluid connection by means of a fixing screw at an axial and radial distance from housing parts of the attachment part. As, due to the use of filter elements in the hydraulic operating circuit, magnetisable particulate contamination should thus only arise rarely, manual cleaning of the magnetic-field-generating device is therefore not absolutely essential because a potentially large amount of dirt is expected to accrue. However, it is then possible, in any event, to remove the magnetic-field-generating device from the fluid port via the fixing screw for cleaning and/or replacement purposes, and, after cleaning or carrying out maintenance work respectively, re-insert it back in the fluid passage in the attachment part for further operation. It is then not necessary to disconnect the hydraulic accumulator from the rest of the hydraulic circuit for a corresponding precautionary removal of the permanent magnet. In some embodiments, the fixing screw may be designed as a so-called magnetic plug and thus form parts of the active permanent magnet. For example, in this case, the attachment part is also made from non-magnetisable material, such as stainless steel, for example, to prevent metallic particles remaining suspended in the corresponding fixing opening in the attachment part when unscrewing the fixing screw as part of the permanent magnet or the magnetic plug. As such, the particles can also be completely removed from the magnetic-field-generating device more easily.

In order to counteract any leaks and possible leak points, a seal is provided at the connection point between the attachment part and the accumulator housing, generally in the form of at least one O-ring seal. A corresponding seal may, however, also be omitted provided that the attachment part is an integral component of the associated housing lid of the accumulator housing.

To ensure energy-efficient use with full operating capacity, it is for example provided that the hydraulic accumulator is designed such that the separating element is formed by a separating piston that can be displaced longitudinally inside the accumulator housing, said separating piston, in one of its possible stop positions, being in flush contact with the housing lid having the fluid port and covering this without any offset when the fluid chamber is completely drained. During operation of the separating piston, especially when returning the hydraulic liquid from the liquid chamber in the direction of the hydraulic operating circuit, high fluid flow speeds arise, which, in some cases, allows the magnetic-field-generating device to be cleaned by this fluid flow, the collected and discharged particulate contamination therein then being able to be cleaned from the fluid flow via a filter element during standard filtration operation. In this manner, when supplying fluid into the accumulator, the contamination can therefore be cleaned by means of the magnetic-field-generating device and, in the countercurrent, or during discharge operation of the hydraulic accumulator respectively, the device can be cleaned of the aforementioned particulate contamination in the return flow, in other words during accumulator discharge. The separating piston may form a hollow piston to increase the volume of the gas chamber in the direction of the gas side; a corresponding hollow piston design is, however, also possible, additionally or alternatively, in the reverse arrangement on the fluid side so that the piston does not impact the housing lid towards the liquid side with its entire surface under high pressure conditions. Furthermore, it is also possible to design the separating piston as a solid structure in the form of a cylindrical plate, to ensure that the corresponding separating piston is unable to impact the housing lid on the gas side in the event of high operating pressures.

The hydraulic accumulator according to the teachings herein is discussed in greater detail below with reference to further embodiments, shown in the drawings, which are in outline and not to scale. Specific references to components, process steps, and other elements are not intended to be limiting. Further, it is understood that like parts bear the same or similar reference numerals when referring to alternate FIGS.

The hydraulic accumulator shown in FIG. 1 in the form of a so-called piston accumulator comprises a separating piston 12 as a separating element 10, said piston separating two fluid chambers 16, 18 arranged in an accumulator housing 14 from one another. The upper fluid chamber 16, viewed as shown on FIG. 1, forms a closed accumulator chamber 20 for receiving a working gas, such as nitrogen gas, for example. The lower fluid chamber 18, opposite thereto, forms a liquid chamber 22 for the purpose of receiving an operating liquid, such as hydraulic oil for example. The corresponding fluid chamber 18, or liquid chamber 22 respectively, is furnished with a channel-like fluid port 24, via which the accumulator can be connected to an attachment part 26. The corresponding attachment part 26 and thus also the hydraulic accumulator can in turn, although this is not shown in greater detail, be connected via pipework, for example, to a hydraulic operating circuit of the conventional kind.

The accumulator housing 14 is designed as a kind of circular hollow cylinder or cylindrical tube, which, at both free ends thereof, is tightly sealed by a screwed-in housing lid 28, 30 in each case, between which the separating piston 12 is guided, in a freely displaceable manner, along the longitudinal axis 32 of the housing. The upper housing lid 28 comprises a through fluid channel 34, which is sealed by a screw plug 36 as shown in FIG. 1. By means of the corresponding connecting arrangement 34, 36, the accumulator can, if necessary, be drained of working gas in chamber 16, for example for maintenance purposes; but the corresponding chamber 16 can also be filled if there is insufficient working gas. The separating piston 12 itself is designed as a so-called hollow piston for the purpose of increasing the effective gas volume on the fluid chamber 16 side. The separating piston 12 may, however, also comprise a cavity on the liquid side of the accumulator or be designed as a solid cylindrical body. The outer circumference of the separating piston 12 is guided along the inside of the cylindrical accumulator housing 14 via at least one sealing ring 38 and at least one guide band 40. In a practical realisation, a plurality of such sealing rings and guide bands can be fitted, also in combination with one another, on the outer circumference of the separating piston 12.

As is also shown on the drawing in FIG. 3, a handling aid 42 may be arranged on the outside of the respective housing lid 28, 30, here in the form of four blind holes arranged diametrically opposite the longitudinal axis 32, said holes allowing a corresponding actuating tool to be engaged for the purpose of screwing and unscrewing the respective housing lid 28, 30 more easily into the assigned thread section on the inner circumferential side of the accumulator housing 14.

The previous design of such a hydraulic accumulator, here in the form of a piston accumulator, is standard and is therefore not described in any further detail, or only insofar as is necessary in order to understand the teachings herein.

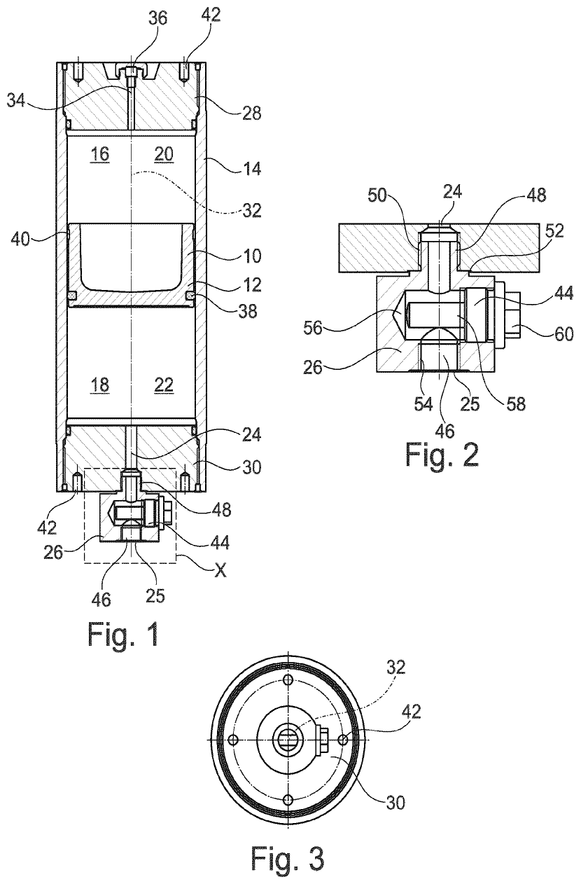

As is shown in particular on the enlarged image according to FIG. 2, a magnetic-field-generating device 44 is fitted in the attachment part 26, said device acting on a cylindrical or channel-shaped fluid connection 46 in the attachment part 26, said fluid connection running between the fluid port 24 of the accumulator housing 14 and an associated fluid port 48 on the attachment part 26. Fluid flows via the corresponding fluid connection 46, originating from the hydraulic supply circuit, into the fluid chamber 18, during an accumulator loading operation, and during an accumulator unloading operation of the hydraulic accumulator said fluid is forced by the preload pressure of the working gas in the first fluid chamber 16 out of the second fluid chamber 18 back into the hydraulic operating circuit again. In particular, the fluid flowing into the accumulator may have a magnetisable, in particular metallic, particulate contamination and, via the magnetic-field-generating device 44 inside the fluid connection 46 of the attachment part 26, the corresponding particulate contamination is prevented from entering the accumulator on the liquid side thereof, formed by the second fluid chamber 18.

The attachment part 26 is formed by a parallelepipedic solid block part with an engagement part 48 arranged on one free end face, which, by forming a threaded section 50, can be screwed into the lower housing lid 30 to establish a fluid passage to the fluid connection 46 in the attachment part 26. A seal 52 is provided between the attachment part 26 arranged on the base and the housing wall of the lower housing lid 30, which is adjacent and opposite thereto, for example in the form of an O-ring seal, which engages around the pin-like engagement part 48, through the centre of which the fluid connection 46 passes continuously.

In a coaxial arrangement with respect to the longitudinal axis 32 of the housing, the fluid connection 46 emerges into the open air at its lower end via a section 54 which is furnished with a female thread on its inner circumference to allow standard pipework, leading to a hydraulic supply circuit (not shown), to be screwed therein. As such, the hydraulic accumulator with its accumulator housing 14 and the attachment part 26 can be fluidically connected to further hydraulic structural components.

In the attachment part 26, from the outside when viewed on FIGS. 1 to 3, from the right, the magnetic-field-generating device 44 is fitted in the fluid connection 46. For this purpose, the fluid connection is designed as a kind of T-connection piece, forming a fluid chamber 56 arranged in the centre in the form of a blind hole with the largest free channel cross-section of the entire fluid connection 46, which extends with its longitudinal orientation transversely with respect to the longitudinal axis 32 of the housing and thus transversely with respect to the other connection parts of the fluid connection 46. In this process, the free diameter in the section 54 is chosen so that it is larger than the inner diameter region of the hollow-cylindrical engagement part 48. The magnetic-field-generating device 44 is formed by a permanent magnet with a magnetic rod 58, which is screwed into the fluid chamber 56, transversely with respect to the rest of the fluid connection 46, by means of a fixing screw 60 at an axial and radial distance from the housing parts of the attachment part 26. In order to increase the magnetic force, the fixing screws 60 can also be formed by a magnetic material. The housing parts of the attachment part 26 itself are, however, for example, formed by non-magnetisable material, for example by stainless steel material. If magnetisable particles then collect on the rod 58 and/or the screw 60, as part of standard maintenance operations, without the need to dismantle the accumulator itself, the magnetic rod 58 can be removed from the attachment part 26 via the fixing screw 60 and cleaned. After screwing in the magnetic-field-generating device 44 in the form of the aforementioned permanent magnet, the particle collection function is then once more available during operation of the hydraulic accumulator. If the change in magnetic field lines in the design are taken into account, it would also be possible to manufacture the attachment part 26 from magnetisable material.

As is also shown in FIGS. 1 and 2, the attachment part 26 can also be used retrospectively as a so-called retrofit kit on hydraulic accumulators that have already been delivered. It is also fundamentally possible to design the attachment part 26 such that it is an integral part of the housing lid 30 so that the threaded section 50 can then also be omitted as well as the engagement part 48, along with the seal 52 in the region of the attachment part 26 and the lower sealing wall or outer wall respectively of the housing lid 30.

The embodiments described below are only explained insofar as they differ substantially from the preceding embodiment. In this case, the same components are provided with the same reference numerals and the remarks made previously in this respect also apply to the embodiments modified accordingly.

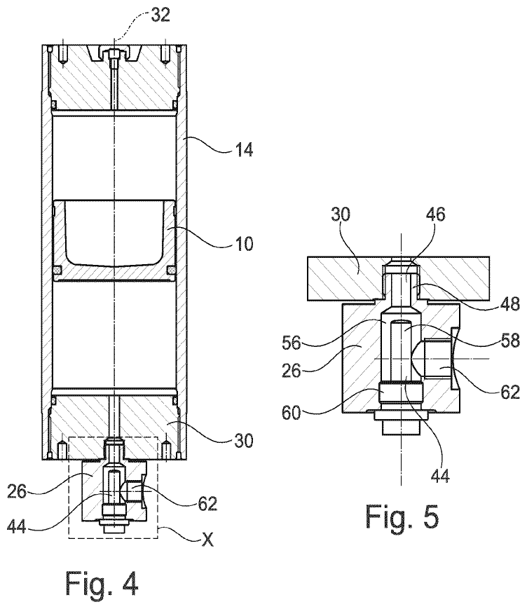

In the solution according to FIGS. 4 and 5, the magnetic-field-generating device is fitted in the T-shaped fluid connection region on the underside of the attachment part 26 as shown on the figures such that the free fluid flow is guided to the right over the attachment part 26. The pipework, which is not shown, for a hydraulic operating circuit can in turn be connected to the corresponding inlet and/or outlet point 62. The fluid chamber 56 with the magnetic-field-generating device 44 is then received in the block-shaped attachment part 26 coaxially with respect to the longitudinal axis 32 of the housing of the piston accumulator. As such, the magnetic rod 58, or a magnetic plug rule 60 respectively, at a corresponding axial and radial distance from the fluid chamber 56, is inserted, in particular screwed, into the attachment part 26 from beneath, coaxially with respect to the longitudinal axis 32 of the housing. In the corresponding embodiment, the free end of the magnetic rod 58 in any event emerges into the associated fluid connection 46 beneath the engagement part 48. By virtue of the fact that the fixing screw 60 with the magnetic rod 58 is screwed into the attachment part 26 from beneath, this creates a kind of fluid barrier, which promotes the right-angled deflection of the fluid flow during the accumulator discharge operation in the direction of the inlet and/or outlet point 62.

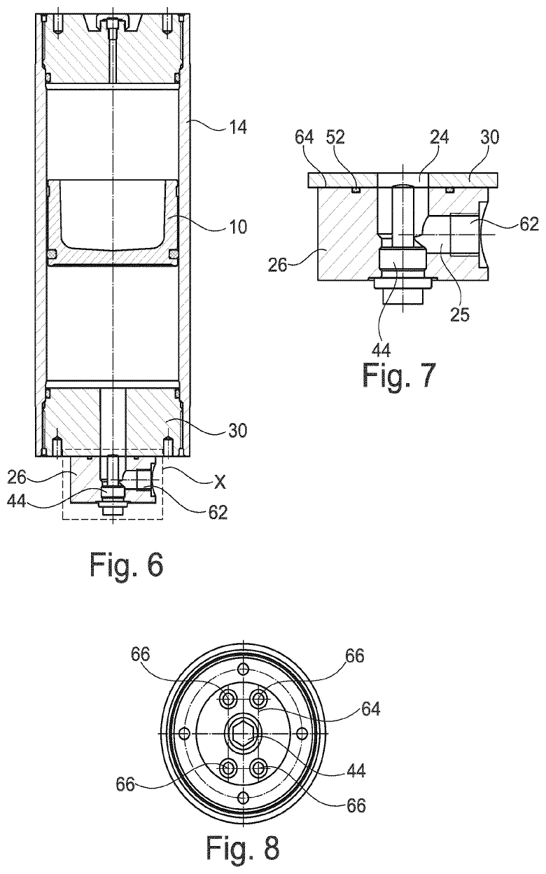

In the embodiment according to FIGS. 6 to 8, the parallelepipedic attachment part 26 is detachably connected to the underside of the lower housing lid 30 by a flat flange plate 64, which is only reproduced in outline in FIG. 8, by means of four fixing screws 66. Similarly to the embodiment according to FIGS. 4 and 5, the magnetic-field-generating device 44 is in this case once again fitted into the attachment part 26 from beneath with a right-angled connection point 62. In this case, the free end of the magnetic rod 58 extends just into the inlet opening of the channel-like fluid port 24 in the lower housing lid 30. An O-ring seal is once again used to provide the seal 52 between the attachment part 26 and the lower housing lid 30. As shown by a direct comparison of the embodiments according to FIGS. 1 to 5 with the embodiment according to FIGS. 6 to 8, the flange plate fixing for the attachment part 26 on the accumulator housing 14 may lead to a small attachment depth, which saves space.

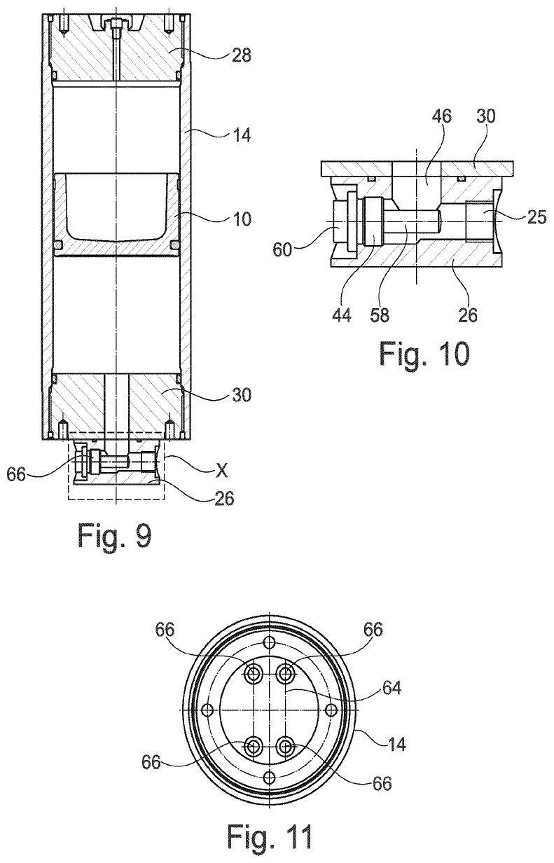

Compared to the embodiment described above, according to the configuration shown in FIGS. 9 to 12, as viewed on FIGS. 9 and 10, the magnetic-field-generating device 44 is arranged on the left-hand side of the attachment part 26. As such, the attachment part 26 is also fixed as a kind of flange plate on the bottom of the accumulator housing by means of individual screws 66 and securely connected to the lower housing lid 30 in this manner. In a particularly pressure-resistant configuration, in this case, the base of the attachment part 26 is designed to be closed, with the fluid connection 46 once again being designed as a T-piece.

The aforementioned embodiments make it clear that, in the form of a modular system, the attachment part 26 can be designed to be more or less identical and, by an appropriate choice of fluid connection 46 and the selected installation space for the magnetic-field-generating device 44 in the attachment part 26, the magnetic-field-generating device 44 can always be fitted to the accumulator housing 14 at readily accessible locations such that it can be detached again afterwards. This therefore has no parallel in the prior art.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A hydraulic accumulator, having a separating element which is arranged in an accumulator housing and separates two fluid chambers from one another in a fluid-tight manner, wherein a fluid port is fluidically connected to one of the fluid chambers, wherein outside the accumulator housing and fixed thereto, is an attachment part with a magnetic-field-generating device which acts on a fluid connection between the fluid port of the accumulator housing and a fluid port of the attachment part in such a way that magnetisable particles can be separated in a cleaning manner from the fluid passing through the fluid connection.

12. The hydraulic accumulator of claim 11, wherein the attachment part is configured as a cuboid or parallelepiped and, furnished with an engagement part, is screwed into the accumulator housing or connected flush with the accumulator housing via a flange plate.

13. The hydraulic accumulator of claim 11, wherein the accumulator housing comprises a cylindrical housing wall, which is sealed with a housing lid at at least one end, said housing lid comprising the attachment part on its outer side facing away from the separating piston.

14. The hydraulic accumulator of claim 11, wherein the fluid connection inside the attachment part runs in a straight line, coaxially with respect to the fluid port, in the accumulator housing, or at right angles thereto, and wherein the magnetic-field-generating device is arranged transversely, at least with respect to parts of the fluid connection and engaging in said fluid connection in the attachment part.

15. The hydraulic accumulator of claim 11, wherein the magnetic-field-generating device is formed by a permanent magnet.

16. The hydraulic accumulator of claim 11, wherein the permanent magnet comprises a magnetic rod, which is inserted into the fluid connection using a fixing screw at an axial and radial distance from housing parts of the attachment part.

17. The hydraulic accumulator of claim 11, wherein the fixing screw, configured as a magnetic plug, is part of the permanent magnet.

18. The hydraulic accumulator of claim 11, wherein the attachment part is made of non-magnetisable material.

19. The hydraulic accumulator of claim 11, wherein a seal is provided at a connection point between the attachment part and the accumulator housing.

20. An attachment part for a retrofit kit for a piston accumulator, wherein a magnetic-field-generating device is inserted into a fluid connection inside a mounting block, said fluid connection comprising two fluid port points leading to the outside.

21. The hydraulic accumulator of claim 11, wherein the hydraulic accumulator is a piston accumulator.

22. The hydraulic accumulator of claim 11, wherein a first of the two fluid chambers is a closed accumulator chamber for a working gas.

23. The hydraulic accumulator of claim 11, wherein a second of the two fluid chambers is a liquid chamber for an operating liquid such as hydraulic oil.

24. The hydraulic accumulator of claim 12, wherein the accumulator housing comprises a cylindrical housing wall, which is sealed with a housing lid at at least one end, said housing lid comprising the attachment part on its outer side facing away from the separating piston.

25. The hydraulic accumulator of claim 12, wherein the fluid connection inside the attachment part runs in a straight line, coaxially with respect to the fluid port, in the accumulator housing, or at right angles thereto, and wherein the magnetic-field-generating device is arranged transversely, at least with respect to parts of the fluid connection and engaging in said fluid connection in the attachment part.

26. The hydraulic accumulator of claim 13, wherein the fluid connection inside the attachment part runs in a straight line, coaxially with respect to the fluid port, in the accumulator housing, or at right angles thereto, and wherein the magnetic-field-generating device is arranged transversely, at least with respect to parts of the fluid connection and engaging in said fluid connection in the attachment part.

27. The hydraulic accumulator of claim 12, wherein the magnetic-field-generating device is formed by a permanent magnet.

28. The hydraulic accumulator of claim 13, wherein the magnetic-field-generating device is formed by a permanent magnet.

29. The hydraulic accumulator of claim 14, wherein the magnetic-field-generating device is formed by a permanent magnet.

30. The hydraulic accumulator of claim 11, wherein the attachment part is made of stainless steel.
